(19) United States
(12) Patent Application Publication
(10) Pub. No.: US 2007/0194681 A1
(43) Pub. Date: Aug. 23, 2007

(54) Spark plug designed to have enhanced spark resistance and oxidation resistance

(75) Inventor: Koichi Yoshida, Nishikasugai-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/703,826

(22) Filed: Feb. 8, 2007

(30) Foreign Application Priority Data
Feb. 8, 2006 (JP) 2006-031409

(51) Int. Cl. H01T 13/20

(52) U.S. Cl. 313/141; 313/143

(57) ABSTRACT

A spark plug for an internal combustion engine is provided which is equipped with a ground electrode and a center electrode. The spark plug also has a ground electrode noble metal chip joined to the ground electrode and a center electrode noble metal chip joined to the center electrode to define a spark gap between itself and the ground electrode. At least one of the ground electrode chip and the center electrode chip is made from material containing a main component of Rh (Rhodium) and an additive of 0.3% to 2.5% by weight of one or more selected from earth rare elements, IVA elements, and VA elements. This results in enhanced resistances of the one of the center electrode and ground electrode chips to wear arising from exposure to sparks and oxidation in high-temperature environments.

### CROSS REFERENCE TO RELATED DOCUMENT

The present application claims the benefit of Japanese Patent Application No. 2006-31409 filed on Feb. 8, 2006, the disclosure of which is incorporated herein by reference.

### BACKGROUND OF THE INVENTION

1. Technical Field of the Invention

The present invention relates generally to a spark plug for internal combustion engines which may be employed in automotive vehicles, cogeneration systems, or gas feed pumps, and more particularly to such a spark plug designed to ensure increased spark resistance and oxidation resistance.

2. Background Art

Spark plugs are usually used in internal combustion engines such as ones mounted in automotive vehicles. Such a type of spark plug is equipped with a center electrode and a ground electrode which define a spark gap therebetween. A series of sparks are produced in the spark gap to ignite an air-fuel mixture. In order to improve the sparkability in the spark gap, the ignitability of the mixture, and the durability of the center and ground electrodes, there are used spark plugs having noble metal chips affixed to opposed faces of the center and ground electrodes. For example, Japanese Patent First Publication No. 2003-317896 discloses such a spark plug. The noble metal chips typically include Ir (Iridium) or Pt (Platinum).

In recent years, the temperature of a combustion chamber of the engine has been getting high with the enhancement of performance of the internal combustion engines, thus requiring the need for the improvement of durability of the noble metal chips. For example, when the temperature of the combustion chamber rises up to about 100° C., it may result in increased wear of the noble metal chips. Typical causes of such wear are the instantaneous melting of the electrodes by the energy of sparks and the oxidation of the noble metal chips.

When the noble metal chips whose major component is Ir are used in hot environments, it may cause Ir to be oxidized and volatilized. The noble metal chips made of Pt may be melted by exposure to a series of sparks and worn. It is, thus, difficult to meet present-day requirements to increase the service life of the spark plug.

Rh (rhodium) which has high melting points and is hardly oxidized and volatilized may be used to control the spark-caused wear and the oxidation/volatilization of the noble metal chips. The fragility that is the mechanical property of Rh may, however, result in breakage of the noble metal chips when subjected to thermal stress, as produced by the heat in the combustion chamber. Such breakage seems to be caused by the intergranular cracking (also called intercrystalline cracking).

### SUMMARY OF THE INVENTION

It is therefore a principal object of the invention to avoid the disadvantages of the prior art.

It is another object of the invention to provide an improved structure of a spark plug for internal combustion engines which is designed to have enhanced resistances to wear arising from exposure to sparks and oxidation.

According to one aspect of the invention, there is provided a spark plug for internal combustion engines employed in, for example, automotive vehicles, cogeneration systems, or gas feed pumps. The spark plug comprises: (a) a ground electrode having a center electrode facing surface; (b) a center electrode having a ground electrode facing surface; (c) a ground electrode chip joined to the center electrode facing surface of the ground electrode, the ground electrode chip being made of a noble metal; and (d) a center electrode chip joined to the ground electrode facing surface of the center electrode to define a spark gap between itself and the ground electrode chip. The center electrode chip is made of a noble metal. At least one of the ground electrode chip and the center electrode chip is made from material containing a main component of Rh (Rhodium) and an additive of 0.3% to 2.5% by weight of one or more selected from earth rare elements, IVA elements, and VA elements, as listed in the periodic table of the elements.

Rh usually has a high melting point and is hardly oxidized and volatilized, thus improving the resistances of the at least one of the center and ground electrode chips to the wear due to exposure to sparks and to the oxidation/volatilization in high-temperature environments.

The additive of 0.3% to 2.5% by weight of one or more selected from the earth rare elements, the IVA elements, and the VA elements results in inclusion of oxide grains of desired sizes within the one of the center electrode chip and the ground electrode chip, thereby improving the intergranular strength thereof which improves the strength against the thermal stress to enhance the durability of the one.

In the preferred mode of the invention, the material of the center electrode chip may contain a main component of one of Ir (Iridium) and Pt (Platinum). In case of Ir, the center electrode chip has enhanced resistance to the wear arising from exposure to sparks. In case of Pt, the center electrode chip has enhanced resistance to the oxidization thereof. The ground electrode chip is made from the material containing the main component of Rh and the additive of 0.3% to 2.5% by weight of one or more selected from the earth rare elements, the IVA elements, and the VA elements.

The ground electrode chip may alternatively be made from material containing a main component of Pt. The center electrode chip may alternatively be made from the material containing the main component of Rh and the additive of 0.3% to 2.5% by weight of one or more selected from the earth rare elements, the IVA elements, and the VA elements.

The at least one of the ground electrode chip and the center electrode chip may be made from the material containing the main component of Rh and the additive of 0.3% to 2.5% by weight of one or more selected from Sc (scandium), Y (yttrium), La (lanthanum), Zr (zirconium), Hf (hafnium), Nb (niobium), or Ta (tantalum). This results in an improved mechanical strength of the at least one of the ground electrode chip and the center electrode chip.

According to another aspect of the invention, there is provided a spark plug for an internal combustion engine which comprises: (a) a ground electrode having a center electrode facing surface; (b) a center electrode having a ground electrode facing surface; and (c) a center electrode chip joined to the ground electrode facing surface of the center electrode to define a spark gap between itself and the center electrode facing surface of the ground electrode. The center electrode facing surface of the ground electrode is made from material containing a main component of Ni. The center electrode chip is made from material containing a main component of Rh and an additive of 0.3% to 2.5% by weight of one or more selected from earth rare elements, IVA elements, and VA elements.

In the preferred mode of the invention, the center electrode chip may be made from the material containing the main component of Rh and the additive of 0.3% to 2.5% by weight of one or more selected from Sc (scandium), Y (yttrium), La (lanthanum), Zr (zirconium), Hf (hafnium), Nb (niobium), or Ta (tantalum).

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the. purpose of explanation and understanding only.

In the drawings:

FIG. 1 is a partially longitudinal sectional view which shows a spark plug according to the first embodiment of the invention;

FIG. 2 is a partially side view which shows a top portion of the spark plug of FIG. 1;

FIG. 3 is a partially side view which shows a top portion of a spark plug according to the fourth embodiment of the invention; and

FIG. 4 is a partially side view which shows a top portion of a spark plug according to the fifth embodiment of the invention.

### DESCRIPTION OF THE PREFERRED EMBODIMENTS

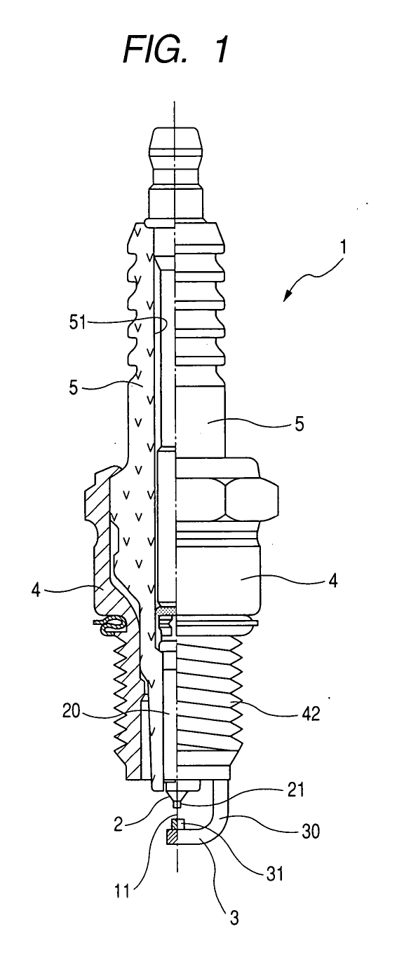

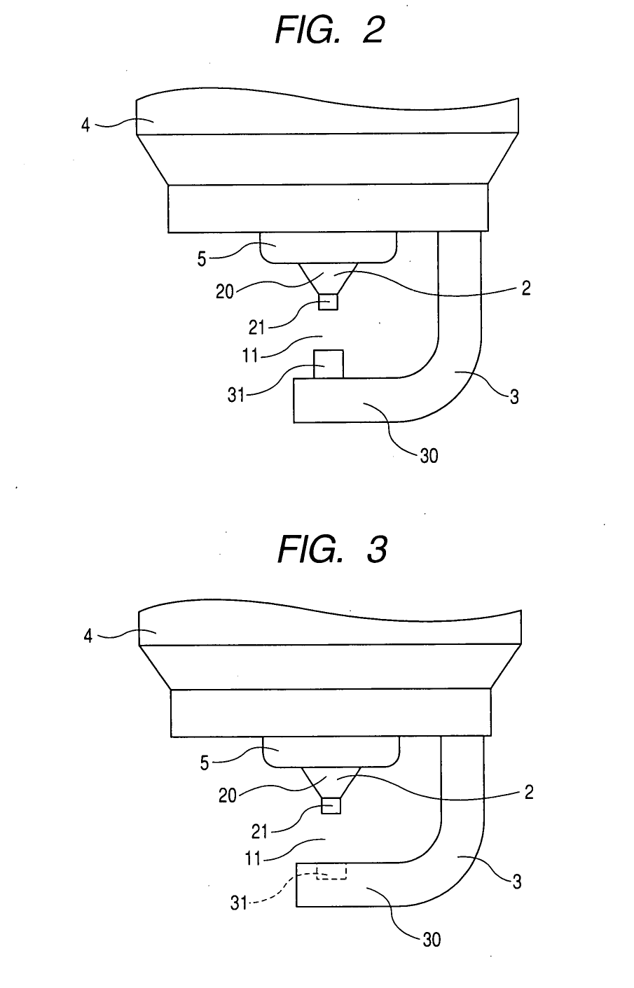

Referring now to the drawings, particularly to FIGS. 1 and 2, there is shown a spark plug 1 according to the first embodiment of the invention which may be employed in internal combustion engines.

The spark plug 1 includes a center electrode 2 and a ground electrode 3 which define a spark gap 11 therebetween. The center electrode 2 and the ground electrode 3 have faces which are opposed to each other and to which a center electrode chip 21 and a ground electrode chip 31 are affixed, respectively. The center electrode chip 21 and the ground electrode chip 31 are made of noble metals.

Specifically, the center electrode chip 21 and the ground electrode chip 31 are each made from material containing a main component of Rh (rhodium) and an additive of 0.3% to 2.5% by weight of one or more selected from earth rare elements, IVA elements, and VA elements.

The content of Rh of each of the center electrode chip 21 and the ground electrode chip 31 is 50% by weight or more.

The additive(s) to Rh in the material of the center electrode chip 21 and the ground electrode chip 31 is preferably selected from Sc (scandium), Y (yttrium), or La (lanthanum) that is one of the earth rare elements, Zr (zirconium) or Hf (hafnium) in the group of IVA elements, or Nb (niobium) or Ta (tantalum) in the group of the VA elements in terms of the improvement of distribution of mechanical strength.

The spark plug 1, as clearly illustrated in FIG. 1, also includes a porcelain insulator 5 and a metal shell 4.

The porcelain insulator 5 has defined therein a center through hole 51 in which the center electrode 2 is retained with the top thereof extending outside the top end of the porcelain insulator 5. The metal shell 4 retains therein the porcelain insulator 5 and has a plug-installation thread 42 for installing the spark plug 1 in the engine. The ground electrode 3 is joined to the metal shell 4 and extends to define the spark gap 11 between itself and the top end of the center electrode 2.

The center electrode 2 includes a center electrode base material 20 which has the center electrode chip 21 welded to the surface of the top end thereof. Similarly, the ground electrode 3 includes a ground electrode base material 30 which has the ground electrode chip 31 welded to the surface thereof facing the top end of the center electrode 2. Each of the center electrode chip 21 and the ground electrode chip 31 is cylindrical in shape. The center electrode chip 21 has a diameter of 0.3 mm to 1.1 mm and a length of 0.2 mm to 1.0 mm in an axial direction of the spark plug 1. The ground electrode chip 31 has a diameter of 0.4 mm to 1.2 mm and a length of 0.2 mm to 1.0 mm in the axial direction of the spark plug 1.

The center electrode base material 20 and the ground electrode base material 30 are each made from Ni (Nickel) alloy.

As described above, each of the center electrode chip 21 and the ground electrode chip 31 is made from material whose major component is Rh. Rh usually has a high melting point and is hardly oxidized and volatilized, thus improving the resistances of the center and ground electrode chips 21 and 31 to the wear due to exposure to sparks and to the oxidation/volatilization during use in the engine.

The material of each of the center electrode chip 21 and the ground electrode chip 31 also contains an additive of 0.3% to 2.5% by weight of one or more selected from the earth rare elements, the IVA elements, and the VA elements, thereby resulting in an increased mechanical strength against the intergranular cracking and ensuring the durability against the thermal stress. Specifically, such an additive results in inclusion of oxide grains of desired sizes within the alloys of the center electrode chip 21 and the ground electrode chip 31, thereby improving the intergranular strength thereof. Particularly, the earth rare elements, the IVA elements, and the VA elements have solid solubility with respect to Rh, thus resulting in the inclusion of oxide grains of desired sizes within the alloys to improve the durability of the center electrode chip 21 and the ground electrode chip 31.

The spark plug 1 of the second embodiment of the invention will be described below.

The center electrode chip 21 is made from material containing a main component of Rh and an additive of 0.3% to 2.5% by weight of one or more selected from the earth rare elements, the IVA elements, and the VA elements. The ground electrode chip 31 is made of alloy containing a main component of 50% or more by weight of Pt, thereby resulting in enhanced resistance to oxidization thereof. Other arrangements are identical with those in the first embodiment, and explanation thereof in detail will be omitted here.

The spark plug 1 of the third embodiment of the invention will be described below.

The ground electrode chip 31 is made from material containing a main component of Rh and an additive of 0.3% to 2.5% by weight of one or more selected from the earth rare elements, the IVA elements, and the VA elements. The center electrode chip 21 is made of alloy containing a main component of 50% or more by weight of Ir or Pt. In case of Ir, the center electrode chip 21 has enhanced resistance to wear arising from exposure to sparks. In case of Pt, the center electrode chip 21 has enhanced resistance to oxidization thereof. Other arrangements are identical with those in the first embodiment, and explanation thereof in detail will be omitted here.

FIG. 3 shows the spark plug 1 of the fourth embodiment of the invention which is designed to have the ground electrode chip 31 embedded in the surface of the ground electrode base material 30 to define the spark gap 11. The ground electrode base material 30 is made of Ni.

Each of the center electrode chip 21 and the ground electrode chip 31 is made from material containing a main component of Rh (rhodium) and an additive of 0.3% to 2.5% by weight of one or more selected from the earth rare elements, the IVA elements, and the VA elements. Other arrangements are identical with those in the first embodiment, and explanation thereof in detail will be omitted here.

Either of the center electrode chip 21 or the ground electrode chip 31 may be made of the same Rh alloy as that in the second or third embodiment.

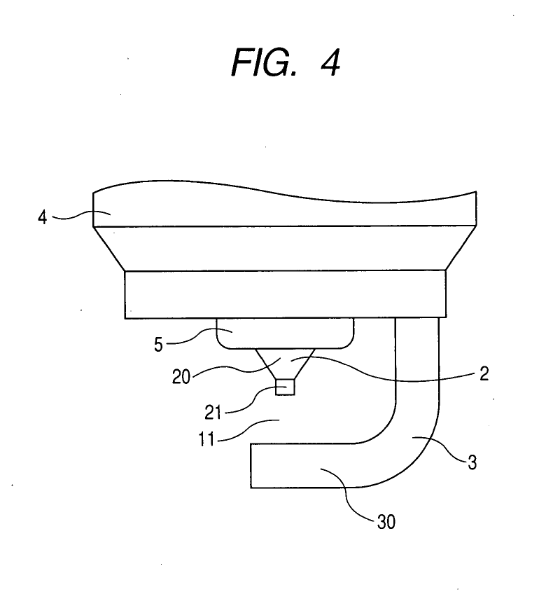

FIG. 4 shows the spark plug 1 of the fifth embodiment of the invention which is designed to have the ground electrode 3 made only of the ground electrode base material 30 whose main component is Ni.

Specifically, the ground electrode 3 has no noble metal chip and is formed only by material containing a main component of Ni.

The center electrode 2, like the first embodiment, has the center electrode chip 21 facing the ground electrode chip 31 to define the spark gap 11. The center electrode chip 21 is made from material containing a main component of Rh and an additive of 0.3% to 2.5% by weight of one or more selected from the earth rare elements, the IVA elements, and the VA elements.

The additive(s) to Rh in the material of the center electrode chip 21 is preferably selected from Sc, Y, or that is one of the earth rare elements, Zr or in the group of IVA elements, or Nb or Ta in the group of the VA elements. Other arrangements are identical with those in the first embodiment, and explanation thereof in detail will be omitted here.

The inventor of this application performed tests on relations of compositions of the Rh-alloys used in making the center electrode chip 21 and the ground electrode chip 31 to the resistances to oxidization and spark-caused wear and the mechanical strength. Results of such tests are shown in table 1.

Specifically, the inventor prepared test samples of the spark plug 1 with the center electrode chip 21 and the ground electrode chip 31 which were made of Rh-alloys identical in compositions and evaluated the oxidation resistance, the spark-caused wear resistance, and the mechanical strength thereof for different kinds and amounts of the additive element(s). The structures of the center electrode chip 21 and the ground electrode chip 31 are the same as those in the first embodiment. Each of the center electrode chip 21 and the ground electrode chip 31 is cylindrical in shape and has a diameter of 0.5 mm and a length of 0.8 mm.

The evaluation of the oxidation resistance was achieved by leaving the samples at 1200° C. for twenty (20) hours in the air and measuring a change in weight before and after it as an increase in amount of oxides. Ones of the samples experiencing a weight change less than or equal to ±5% are determined to be good and expressed by “O” in the table 1. Ones of the samples experiencing a weight change greater than ±5% are determined to be bad and expressed by “X” in the table 1.

The evaluation of the spark-caused wear resistance was achieved by performing durability tests on the samples and measuring a resulting increase in size of the spark gap 11. Specifically, the durability tests were performed by mounting the samples were mounted in a six-cylinder two-liter engine and running the engine at full throttle at 6000 rpm for 300 hours. Ones of the samples whose increase in size of the spark gap 11 is less than or equal to 0.2 mm are determined to be good and expressed by “O”in the table 1. Ones of the samples whose increase in size of the spark gap 11 is more than 0.2 mm are determined to be bad and expressed by “X” in the table 1.

The evaluation of the mechanical strength was achieved by observing the presence of cracks in the center electrode chip 21 or the ground electrode chip 31. Ones of the samples having no cracks are determined to be good and expressed by “O” in the table 1. Ones of the samples having cracks are determined to be bad and expressed by “X” in the table 1.

Only ones of the samples, as evaluated to be the non-defective products in all the above items, are comprehensively evaluated as non-defective products, as expressed by “O” in the table 1. The other samples are comprehensively evaluated as defective products, as expressed by “X” in the table 1.

In table 1, no data on the spark-caused wear resistance means that cracks occurred in either of the center electrode chip 21 or the ground electrode chip 31, and it was impossible to evaluate the spark-caused wear resistance.

TABLE 1

| | | Added | Oxidation resistance | | Spark resistance | | | |
|---|---|---|---|---|---|---|---|---|
| Sample | Additive | amount | Oxide | | Gap | | | Comprehensive |
| No. | element | Wt % | increase | Evaluation | increase | Evaluation | Crack | Evaluation |
| No. 1 | Non | — | 0.01% | ∘ | — | — | x | x |
| No. 2 | Zr | 0.2 | 0.01% | ∘ | — | — | x | x |
| No. 3 | Zr | 1 | 0.02% | ∘ | +0.07 mm | ∘ | ∘ | ∘ |
| No. 4 | Zr | 2.5 | 0.10% | ∘ | +0.08 mm | ∘ | ∘ | ∘ |
| No. 5 | Zr | 4 | 0.15% | ∘ | — | ∘ | x | x |
| No. 6 | Ti | 1 | 0.03% | ∘ | +0.06 mm | — | ∘ | ∘ |
| No. 7 | Hf | 1 | 0.02% | ∘ | +0.05 mm | ∘ | ∘ | ∘ |
| No. 8 | Sc | 1 | 0.03% | ∘ | 0.08 mm | ∘ | ∘ | ∘ |
| No. 9 | Y | 0.5 | 0.02% | ∘ | +0.06 mm | ∘ | ∘ | ∘ |
| No. 10 | La | 0.5 | 0.03% | ∘ | +0.07 mm | ∘ | ∘ | ∘ |
| No. 11 | Nb | 1.5 | 0.20% | ∘ | +0.06 mm | ∘ | ∘ | ∘ |
| No. 12 | Ta | 1.5 | 0.15% | ∘ | +0.07 mm | ∘ | ∘ | ∘ |
| No. 13 | Zr | 5 | 0.50% | ∘ | — | — | x | x |
| No. 14 | W | 2 | −1.50% | X | — | — | x | x |
| No. 15 | Re | 2 | −0.04% | ∘ | — | — | x | x |
| No. 16 | Re | 10 | −8% | x | +0.23 mm | x | x | x |

Note that Nos. 1, 2, 5, 13 to 16 indicate comparative ones of the test samples, and Nos. 3, 4, and 6 to 12 indicate the other test samples belonging to the invention.

The table 1 shows that ones of the test samples, as comprehensively evaluated as the non-defective products, are equipped with the center electrode chip 21 and the ground electrode chip 31 which are made from material containing a main component of Rh and an additive of 0.3% to 2.5% by weight of one or more selected from the earth rare elements, the IVA elements, and the VA elements and exhibit enhanced spark-caused wear resistance and oxidation resistance.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A spark plug for an internal combustion engine comprising:
a ground electrode having a center electrode facing surface;
a center electrode having a ground electrode facing surface;
a ground electrode chip joined to the center electrode facing surface of said ground electrode, said ground electrode chip being made of a noble metal; and
a center electrode chip joined to the ground electrode facing surface of said center electrode to define a spark gap between itself and said ground electrode chip, said center electrode chip being made of a noble metal,
wherein at least one of said ground electrode chip and said center electrode chip is made from material containing a main component of Rh (Rhodium) and an additive of 0.3% to 2.5% by weight of one or more selected from earth rare elements, IVA elements, and VA elements.

2. A spark plug as set forth in claim 1, wherein said center electrode chip is made from material containing a main component of one of Ir (Iridium) and Pt (Platinum), and wherein said ground electrode chip is made from the material containing the main component of Rh and the additive of 0.3% to 2.5% by weight of one or more selected from the earth rare elements, the IVA elements, and the VA elements.

3. A spark plug as set forth in claim 1, wherein said ground electrode chip is made from material containing a main component of Pt, and wherein said center electrode chip is made from the material containing the main component of Rh and the additive of 0.3% to 2.5% by weight of one or more selected from the earth rare elements, the IVA elements, and the VA elements.

4. A spark plug as set forth in claim 1, wherein the at least one of said ground electrode chip and said center electrode chip is made from the material containing the main component of Rh and the additive of 0.3% to 2.5% by weight of one or more selected from Sc (scandium), Y (yttrium), La (lanthanum), Zr (zirconium), Hf (hafnium), Nb (niobium), or Ta (tantalum).

5. A spark plug for an internal combustion engine comprising:
a ground electrode having a center electrode facing surface;
a center electrode having a ground electrode facing surface; and
a center electrode chip joined to the ground electrode facing surface of said center electrode to define a spark gap between itself and the center electrode facing surface of said ground electrode,
wherein the center electrode facing surface of said ground electrode is made from material containing a main component of Ni, and
wherein said center electrode chip is made from material containing a main component of Rh and an additive of 0.3% to 2.5% by weight of one or more selected from earth rare elements, IVA elements, and VA elements.

6. A spark plug as set forth in claim 5, wherein said center electrode chip is made from the material containing the main component of Rh and the additive of 0.3% to 2.5% by weight of one or more selected from Sc (scandium), Y (yttrium), La (lanthanum), Zr (zirconium), Hf (hafnium), Nb (niobium), or Ta (tantalum).
